(19) United States
(12) Patent Application Publication
(10) Pub. No.: US 2007/0261000 A1
(43) Pub. Date: Nov. 8, 2007

(54) Control System for a Motor Vehicle

(75) Inventors: Volker Hellwig, Stuttgart (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrylsler AG, Stuttgart (DE)

(21) Appl. No.: 10/583,889

(22) PCT Filed: Dec. 7, 2004
(86) PCT No.: PCT/EP04/13893

§ 371 Date: Apr. 3, 2007

(30) Foreign Application Priority Data
Dec. 23, 2003 (DE) 10360664.5

(51) Int. Cl. G06F 3/048

(52) U.S. Cl. 715/810

(57) ABSTRACT

A control system for a motor vehicle is provided, having a manual operating device with a plurality of degrees of freedom for selecting and/or activating entries in a menu structure with a plurality of menu levels, and a screen display with a plurality of presentation areas representing the menu structure, where the presentation areas respectively include at least one field for presenting one of the entries. In at least one menu level in one of the presentation areas, at least one first entry or parameter can be selected and/or activated or altered by a first or second adjusting movement which corresponds to an orientation of the at least one presented entry or parameter in an active presentation area on the screen display, wherein the active presentation area is exited by a right-angled third or fourth adjusting movement.

### CROSS REFERENCE TO RELATED APPLICATIONS

This application is a national stage of PCT International Application No. PCT/EP2004/013893, filed on Dec. 7, 2004, which claims priority under 35 U.S.C. § 119 to German Patent Application No. 103 60 664.5, filed Dec. 23, 2003, the entire disclosures of which are herein expressly incorporated by reference.

### BACKGROUND AND SUMMARY OF THE INVENTION

The present invention relates to a control system for a motor.

Multimedia control systems are increasingly being used in modern vehicles. An example of this is the command system used in Mercedes Benz S class motor vehicles.

DE 197 52 056 A1 describes a control system of the generic type, particularly for a motor vehicle. This control system involves two presentation areas being displayed on a screen display in a menu structure with a plurality of menu levels. A first presentation area is arranged as a frame around the second presentation area. On a first menu level, the first presentation area displays eight fields with entries which correspond to executable applications and which are arranged vertically and horizontally. An entry is selected by a sliding or tilting movement of a manual operating means in the direction of the position of the relevant entry in the first presentation area. The manual operating means has a plurality of degrees of freedom. Pressing the manual operating means activates a selected entry. Following the activation, a plurality of vertically arranged entries are displayed on a second menu level in the second presentation area, said entries being associated with the activated entry on the first menu level. The entries displayed in the second presentation area are selected by a rotary movement of the manual operating means and are activated by pressing the manual operating means. The activated second presentation area and the second menu level are exited by the sliding or tilting movement of the manual operating means in the direction of a position of one of the entries in the first presentation area. The control system is then back in the first presentation area on the first menu level.

It is an object of the present invention to specify an improved control system for a motor vehicle which allows intuitive control and reduces the scope of distracting information.

This and other objects and advantages are achieved by the control system according to the invention, a first aspect of which is based on the idea that on at least one menu level in at least one presentation area at least one first entry can be selected and/or activated and/or set by an adjusting movement with a first and/or with a second degree of freedom for the manual operating means. The first and the second degrees of freedom for the operating means correspond to the orientation of the at least one entry presented in an active presentation area. At least one second entry can be activated and/or set by subsequently holding the adjusting movement with the first or second degree of freedom for the manual operating means. The at least one active presentation area can be exited by a third and/or a fourth degree of freedom for the manual operating means, which are at right angles to the orientation of the at least one presented first entry.

The orientation of the at least one second entry may correspond to the orientation of the at least one first entry.

The second entry represents a detail presentation of the activated and/or set first entry, for example.

In one advantageous embodiment of the invention, the at least one first entry is in the form of a line strip, with each line representing a selectable subentry of the same type.

By way of example, the at least one first entry can be set by a cursor which is in the form of a bar and which can be positioned on one of the lines using the manual operating means by operating with the first or second degree of freedom.

By way of example, the at least one second entry is in the form of a level indicator, the current level being able to be presented by a cursor which is in the form of an alterable bar and which can be set using the manual operating means by operating with the first or second degree of freedom and subsequently holding the operating means.

The level may indicate a current position or an elapsed time period within the second entry.

In one particularly advantageous embodiment of the invention, the at least one first entry corresponds to a plurality of selectable radio or television stations or music titles or video clips within an audio application and/or a video application and/or a TV application represents. The number of individual lines in the line strip then corresponds to the number of music titles on a CD or DVD or to the number of video clips on a video cassette or DVD, for example.

In one alternative embodiment, the at least one first entry activates a “next entry” function or a “previous entry” function within an audio application and/or a video application and/or a television application.

The second entry activates a “fast forward” function or a “fast rewind” function within an audio application and/or a video application and indicates the current position within the activated and/or set first entry or indicates the playing time already elapsed, which can be altered in the manner described.

If the at least one first entry corresponds to a plurality of radio or television stations or to the “next” or “previous station” function then the second entry activates an automatic station search. The level indicator for the second entry then indicates the current position within the frequency range which is being searched.

A second aspect of the present invention is based on the idea that, in order to set entries which represent parameters, on at least one level of the menu structure at least one first parameter can be altered by an adjusting movement of the manual operating means with a first or second degree of freedom. The first and the second degrees of freedom correspond to an orientation of the alterable parameters in the active presentation area. An adjusting movement with a fifth degree of freedom for the manual operating means allows the altered parameter to be stored after the setting and allows the active presentation area to be exited.

The inventive allocation of the degrees of freedom of the manual operating means to the orientation of the entries or parameters in the activated presentation area allows intuitive setting of the respective parameter and intuitive exiting of the active presentation area. This simplifies the control operations for the user, and the cognitive load is reduced, which means that the user can concentrate better on what is happening on the road.

The at least one first parameter corresponds to a “balance” or “volume” or “bass” or “treble” function, for example, within an audio application.

In one advantageous development of the present invention, at least one second parameter can be altered by an adjusting movement of the manual operating means with a third or a fourth degree of freedom, which correspond to an orientation of the alterable second parameter in the active presentation area. An adjusting movement of the operating means with the fifth degree of freedom allows the altered parameter to be stored after the setting and allows the active presentation area to be exited.

The at least one second parameter may correspond to a “fader” or “volume” or “bass” or “treble” function, for example, within an audio application.

In one advantageous development of the present invention, the first parameter and the second parameter may be altered on the same menu level and in the same presentation area.

In one advantageous refinement, with a vertical arrangement of the at least one entry or of the at least one settable parameter in the active presentation area, the first degree of freedom corresponds to the manual operating means being slid in a positive y direction and the second degree of freedom corresponds to the manual operating means being slid in a negative y direction. The third degree of freedom corresponds to the manual operating means being slid in a positive x direction and the fourth degree of freedom corresponds to the manual operating means being slid in a negative x direction. The fifth degree of freedom corresponds to the manual operating means being pressed in a negative z direction.

With a horizontal arrangement of the at least one entry or of the at least one parameter in the active presentation area, the first degree of freedom corresponds to the manual operating means being slid in the positive x direction and the second degree of freedom corresponds to the manual operating means being slid in the negative x direction. The third degree of freedom corresponds to the manual operating means being slid in the positive y direction and the fourth degree of freedom corresponds to the manual operating means being slid in the negative y direction. The fifth degree of freedom corresponds to the manual operating means being pressed in the negative z direction.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 illustrates a block diagram of a control system for a motor vehicle;

FIG. 2 shows a schematic illustration of a screen display from FIG. 1 on the first menu level;

FIG. 3 shows a schematic illustration of a presentation area of the screen display from FIG. 1 on a further menu level;

FIG. 4 shows a schematic illustration of a presentation area of the screen display from FIG. 1 on a further menu level; and

FIG. 5 shows a schematic illustration of the screen display from FIG. 1 on a further menu level.

### DETAILED DESCRIPTION OF THE DRAWINGS

As illustrated in FIG. 1, the control system 1 for a motor vehicle comprises a screen display 2, a manual operating means 3, a control and evaluation unit 4, and a plurality of vehicle systems, such as a navigation system, a heating and air-conditioning installation, a mobile telephone, a video system, an audio system etc., which are shown in summary as one element 5. The vehicle systems transmit signals to the evaluation and control unit 4, and the control and evaluation unit 4 ascertains current system states from these signals. All applications and/or functions and/or subfunctions and/or options and/or status indicators on various menu levels in a menu structure are controlled by the manual operating means 3. This has seven degrees of freedom for selecting and/or activating entries presented in an active presentation area. It can be slid in four directions as shown by the arrows in FIG. 1, i.e., in a positive x direction, a negative x direction, in a positive y direction or in a negative y direction. In addition, it can be rotated clockwise or counterclockwise about a z axis (not shown) which is perpendicular to the plane of the drawing and can be pressed in the direction of the negative z direction, i.e., into the plane of the drawing.

Rotating the manual operating means 3 clockwise moves a cursor on the screen display 2 rightward or downward on the basis of a horizontal or vertical orientation of the entries shown on the screen display 2, and rotating it counterclockwise moves the cursor leftward or upward. Sliding the manual operating means 3 in FIG. 1 upward, i.e., forward in the direction of the front window, i.e., in the positive y direction, moves the cursor on the screen display 2 upward, and sliding downward in FIG. 1, i.e., backward, in the negative y direction, moves the cursor on the screen display 2 downward. Sliding rightward, i.e., in the positive x direction, moves the cursor on the screen display 2 rightward, and sliding leftward, i.e., in the negative x direction, moves the cursor leftward.

An entry presented on the screen display 2 is selected and/or activated by sliding or rotating the manual operating means 3. Redundantly from vertical sliding along an axis, i.e., from sliding in the y direction, or from horizontal sliding along an axis, i.e., from sliding in the x direction, the manual operating means 3 can be rotated about the z axis. In this context, the direction of sliding for selecting an entry corresponds, in line with the invention, to the orientation of the entries shown in the active presentation area. The sliding direction at right angles to the respective selection sliding direction results in the active presentation area being exited. In addition, activating a selected entry may require the manual operating means 3 to be pressed.

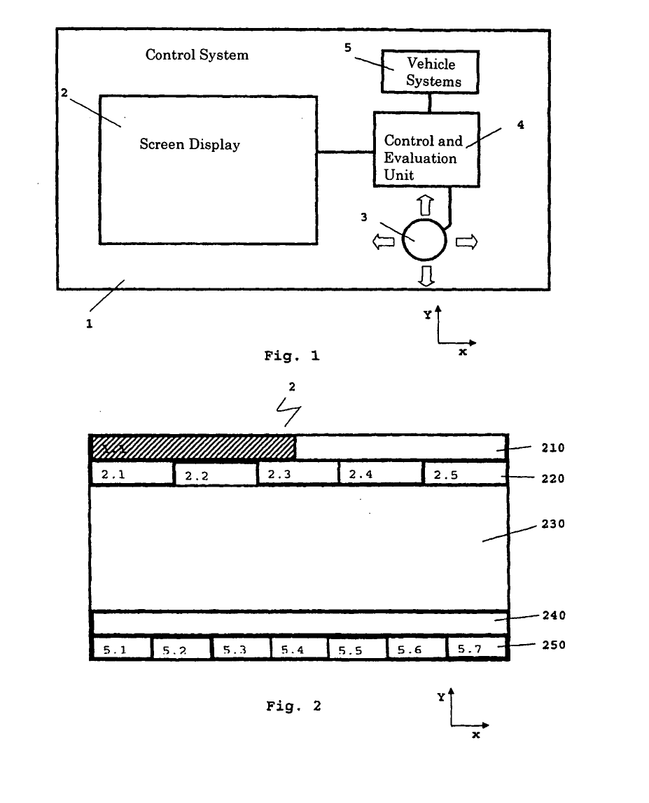

As can be seen from FIG. 2, the screen display 2 comprises, on a first menu level, a graphical base structure of five vertically arranged, horizontal presentation areas 210 to 250. This graphical base structure is constant over the plurality of different menu levels in the menu structure. The screen display 2 may be in the form of an eight-inch screen with a side ratio of 15:9, for example. The graphical base structure of at least a first of the presentation areas 210 to 250 on the screen display 2 is constant over the plurality of different menu levels in the menu structure. In FIG. 2, the presentation areas 210, 220, 240 and 250 are in the form of such first presentation areas.

The graphical base structure of at least a second of the presentation areas 210 to 250 is variable on the basis of an activated application and/or function and/or subfunction and/or option and/or status indicator over the plurality of different menu levels in the menu structure. In FIG. 2, the presentation area 230 is in the form of a second presentation area of this kind. The graphical form of this central presentation area 230 may be very different from the other presentation areas.

The four presentation areas 210, 220, 240 and 250, which are in the form of first presentation areas, can respectively present one or more horizontally arranged entries 1.1 to 5.7. By way of example, the presentation areas 210, 220, 240 and 250 in FIG. 2 respectively comprise a different number of entries on the first menu level. The first presentation area 210 therefore comprises an entry 1.1, the second presentation area 220 comprises five entries 2.1 to 2.5, the fourth presentation area comprises no entry and the fifth presentation area comprises seven entries 5.1 to 5.7. In FIG. 2, the first presentation area 210 is activated and the shaded entry 1.1 is selected. The shaded illustration is intended to indicate that the cursor is on the entry 1.1.

The entries 1.1 to 5.7 in the presentation areas 210 to 250 shown on the screen display 2 may be arranged on the basis of their importance of content or frequency of use. When the entries are arranged vertically, the width of the individual fields for presenting the entries 1.1 to 5.7 is dependent on the length of the longest entry, for example. The field width may additionally or alternatively be dependent on the number of fields in a presentation area.

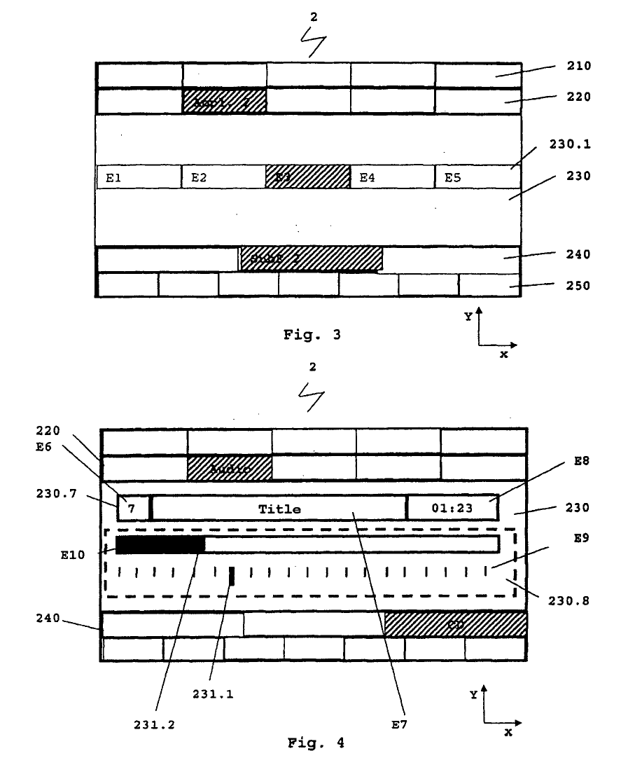

FIG. 3 shows the screen display 2 on a third menu level after an application Appl. 2 has been activated in the second presentation area 220 and a subfunction SubF 2 has been selected and activated in the presentation area 240. In the third presentation area 230, a presentation area 230.1 in the form of a submenu has been activated. The cursor is at a starting position in the presentation area 230.1, from which two first entries E2 and E4 can be selected and activated by means of an appropriate sliding movement of the manual operating means 3. The starting position is the field illustrated by shading, which is denoted by E3. Two second entries E1 and E5 can be selected and activated by a sliding movement in the negative and in the positive x direction and subsequent holding of the manual operating means 3 in this position.

The first entry E4, which can be selected by the sliding movement in the positive x direction, corresponds to a “next entry” function, for example, and the first entry E2, which can be selected by the sliding movement in the negative x direction, corresponds to a “previous entry” function, for example, within an audio application and/or a video application and/or a TV application.

The second entry E5, which can be selected by the sliding movement in the positive x direction and subsequent holding of the operating means 3, corresponds to a “fast forward” function, for example, and a second entry E1, which can be selected by a sliding movement in the negative x direction and subsequent holding, corresponds to a “fast rewind” function, for example, within an audio application and/or a video application. In the case of a radio or television application, the second entry corresponds to a station search function upward or downward within a frequency range.

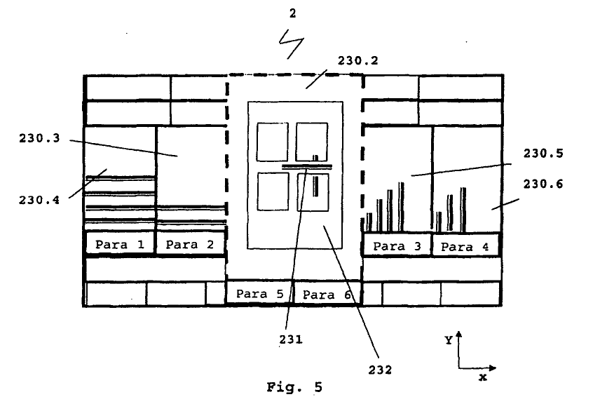

FIG. 4 shows the screen display 2 on a third menu level after an application Audio has been activated in the second presentation area 220 and a subfunction CD has been selected and activated in the presentation area 240. In the third presentation area 230, a presentation area 230.8 with a dashed frame has been activated, which comprises a first entry E9 in the form of a line strip and a second entry E10 in the form of a level indicator. The second entry is a detail presentation of an activated subentry for the first entry. The cursor is in the form of a vertical bar 231.1 in the first entry E9 and is positioned on the seventh subentry. In the exemplary embodiment shown, the subentries represent music titles on a CD. Altogether, there are 20 music titles on the CD, of which the seventh music title has been activated and is currently being played back. A sliding movement by the manual operating means 3 in the positive x direction could currently select and activate the eighth subentry, and a sliding movement in the negative x direction could select and activate the sixth subentry. The cursor in the form of a vertical bar 231.1 would then be positioned on the eighth and on the sixth subentry, respectively.

The cursor is in the form of a horizontal alterable bar 231.2 in the second entry and indicates an already played-back portion of the second entry E10, which represents the total playing time of the seventh music title activated in the first entry E9. Operating the manual operating means 3 with the third degree of freedom, i.e., a sliding movement in the positive x direction and subsequent holding of the manual operating means 3, activates a “fast forward” function, and the length of the horizontal bar 231.2 in the level indicator increases in the positive x direction. Operating the manual operating means 3 with the fourth degree of freedom, i.e., a sliding movement in the negative x direction and subsequent holding of the manual operating means 3, activates a “fast rewind” function, and the length of the horizontal bar 231.2 in the level indicator decreases in the positive x direction.

The selection and/or setting operations proceed in similar fashion when, instead of the subfunction CD, a subfunction DVD or Cassette or Video is activated. In the case of a radio or television function, the subentries for the first entry represent radio or television stations, and the second entry allows a “station search upward” or “station search downward” function to be activated within a presented frequency range in line with the degree of freedom.

In addition, the presentation area 230 shows a further presentation area 230.7 which represents a further detail display of the selected and/or activated subentry within the first entry and which cannot be selected by the user. The presentation area 230.7 is in the form of a horizontally arranged list and, in the exemplary embodiment shown, comprises three entries. The presentation area 230.7, like the second entry E10 in the presentation area 230.8 is coupled to the first entry E9 in the presentation area 230.8. An entry E6 indicates the number of currently selected and/or activated subentries for the first entry E9. An entry E7 indicates the title of the selected and/or activated subentry, and an entry E8 indicates the already played-back playing time of the activated subentry. The presentation area 230.7 has a pure display function and therefore cannot be selected by the user. By way of example, this can be indicated by an altered visual presentation, for example, by a different color and/or intensity.

FIG. 5 shows an example of different presentation areas 230.2 to 230.6 for setting parameters Para 1 to Para 6 within the third presentation area 230. The presentation areas 230.3 and 230.4 are used to set vertically arranged parameters Para 1 and Para 2 by sliding the manual operating means 3 in the positive or negative y direction or by rotating the manual operating means 3 clockwise or counterclockwise.

The presentation areas 230.5 and 230.6 are used to set horizontally arranged parameters Para 3 and Para 4 by sliding the manual operating means 3 in the positive or negative x direction or by rotating the manual operating means 3 clockwise or counterclockwise.

The presentation area 230.2 is used for simultaneously setting two parameters Para 5 and Para 6. The cursor 231 for this setting is in the form of crosshairs which can be moved within a schematically shown vehicle interior, the current value of the parameter Para 5 being shown by the horizontally arranged bar and the current value of the parameter Para 6 being shown by the vertically arranged bar. The parameter Para 5 is set by rotating or vertically sliding the manual operating means 3, and the parameter Para 6 is set by horizontally sliding the manual operating means 3.

By way of example, the parameters Para 1 to Para 4 represent sound functions such as bass, treble, volume etc. and the parameters Para 5 and Para 6 represent sound functions such as balance and fade in an audio application, for example.

One of these presentation areas 230.2 to 230.6 is exited by pressing the manual operating means 3. Following parameter setting, pressing the manual operating means 3 stores the currently set parameter value Para 1 to Para 6 and exits the activated presentation area 230.2 to 230.6.

The inventive allocation of the degrees of freedom for the manual operating means to the orientation of the at least one entry in the activated presentation area and the option of controlling two entries with an internal relationship using a similar movement provides a high recognition value, which allows intuitive control of the respective active presentation area and intuitive exiting of the active presentation area.

The inventive allocation of the degrees of freedom of the manual operating means to the orientation of the entries, which represent settable parameters, in the activated presentation area allows intuitive setting of the respective parameters and intuitive exiting of the active presentation area.

The inventive control system simplifies the control operations for the user, and the cognitive load is reduced, which means that the user can concentrate better on what is happening on the road.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-18. (canceled)

19. A control system for a motor vehicle comprising:
a manual operating device, having a plurality of degrees of freedom for selecting or activating entries in a menu structure with a plurality of menu levels; and
a screen display with a plurality of presentation areas which represent the menu structure, and each of which comprises at least one field for presenting one of the entries; wherein
on at least one level of the menu structure in at least one of the presentation areas, at least one first entry is selected, activated or set by an adjusting movement with a first or a second of the plurality of degrees of freedom for the manual operating device;
first and second degrees of freedom correspond to an orientation of the at least one first entry in at least one active presentation area on the screen display;
at least one second entry is activated or set after the adjusting movement with the first or second degree of freedom, by subsequently holding the manual operating device; and
at least one presentation area which is currently active is exited by an adjusting movement with a third or a fourth degree of freedom for the manual operating device, the third and the fourth degrees of freedom being at right angles to the orientation of the at least one first entry.

20. The control system as claimed in claim 19, wherein the at least one second entry has the same orientation as the at least one first entry.

21. The control system as claimed in claim 19, wherein the at least one second entry represents a detail presentation of the activated or set first entry.

22. The control system as claimed in claim 19, wherein the at least one first entry is in the form of a line strip including a plurality of lines, with each line representing a selectable subentry of the same type.

23. The control system as claimed in claim 22, wherein the at least one first entry is set by a cursor which is in the form of a bar and which is positioned on one of the lines using the manual operating means by operating with the first or second degree of freedom.

24. The control system as claimed in claim 19, wherein the at least one second entry is in the form of a level indicator, the current level being presented by a cursor which is in the form of an alterable bar.

25. The control system as claimed in claim 24, wherein the current level is set using the manual operating device by operating with the first and second degree of freedom and subsequently holding the manual operating device.

26. The control system as claimed in claim 24, wherein the level indicates a current position or an elapsed time period within the second entry.

27. The control system as claimed in claim 19, wherein the at least one first entry represents a plurality of selectable radio or television stations or music titles or video clips within an audio application or a video application or a television application.

28. The control system as claimed in claim 19, wherein the at least one first entry activates one of a “next entry” function and a “previous entry” function within an audio application, a video application or a television application.

29. The control system as claimed in claim 19, wherein the at least one second entry activates or presents one of a “fast forward” function, a “fast rewind” function and a “station search” function within an audio application or a video application or a television application.

30. A control system for a motor vehicle, comprising:
a manual operating device having a plurality of degrees of freedom for selecting or activating entries in a menu structure with a plurality of menu levels; and
a screen display with a plurality of presentation areas for presenting the menu structure, where the presentation areas respectively comprise at least one field for presenting one of the entries; wherein,
at least one entry has at least one associated parameter which is set on at least one level of the menu structure;
at least one first parameter is altered by an adjusting movement of the manual operating device with a first or a second of the plurality of degrees of freedom, where the first or the second degree of freedom corresponds to an orientation of the altered first parameter in the active presentation area; and
an adjusting movement with a fifth degree of freedom for the manual operating device stores the altered first parameter and exits the active presentation area.

31. The control system as claimed in claim 30, wherein the at least one first parameter represents a “balance” or “volume” or “bass” or “treble” function within an audio application.

32. The control system as claimed in claim 30, wherein:
at least one second parameter is altered by an adjusting movement of the manual operating device with a third or a fourth of the plurality of degrees of freedom, where the third or the fourth degree of freedom corresponds to an orientation of the altered second parameter in the active presentation area; and
the altered second parameter is stored by an adjusting movement of the manual operating device with the fifth degree of freedom, and the active presentation area is exited.

33. The control system as claimed in claim 32, wherein the at least one second parameter represents one of a “fader”, “volume”, “bass” and “treble” function within an audio application.

34. The control system as claimed in claim 32, wherein the first and the second parameters are altered on the same menu level and in the same presentation area.

35. The control system as claimed in claim 19, wherein, with a vertical arrangement of the at least one entry or of the at least one parameter in the active presentation area:
the first degree of freedom is the manual operating device being slid in a positive y direction;
the second degree of freedom is the manual operating device being slid in a negative y direction;
the third degree of freedom is the manual operating device being slid in a positive x direction;
the fourth degree of the freedom is the manual operating device being slid in a negative x direction; and
the fifth degree of freedom is the manual operating device being pressed in a negative z direction in an xyz coordinate system.

36. The control system as claimed in claim 19, wherein, with a horizontal arrangement of the at least one entry or of the at least one parameter in the active presentation area:
the first degree of freedom is the manual operating device being slid in a positive x direction;
the second degree of freedom is the manual operating device being slid in a negative x direction;
the third degree of freedom is the manual operating device being slid in a positive y direction;
the fourth degree of freedom is the manual operating device being slid in a negative y direction; and
the fifth degree of freedom is the manual operating device being pressed in a negative z direction in an xyz coordinate system.

37. The control system of claim 20, wherein the at least one second entry represents a detail presentation of the activated or set first entry.

38. The control system of claim 20, wherein the at least one first entry is in the form of a line strip including a plurality of lines, with each line representing a selectable subentry of the same type.
